(19) United States
(12) Patent Application Publication
(10) Pub. No.: US 2026/0214702 A1
(43) Pub. Date: Jul. 23, 2026

(54) CCA THRESHOLD DETERMINATION SYSTEM, CCA THRESHOLD DETERMINATION DEVICE, CCA THRESHOLD DETERMINATION METHOD, AND CCA THRESHOLD DETERMINATION PROGRAM

(71) Applicant: NTT, Inc., Tokyo (JP)

(72) Inventors: Hanae OTANI, Musashino-shi, Tokyo (JP); Hirantha ABEYSEKERA, Musashino-shi, Tokyo (JP); Yusuke ASAI, Musashino-shi, Tokyo (JP); Yasushi TAKATORI, Musashino-shi, Tokyo (JP)

(73) Assignee: NTT, Inc., Tokyo (JP)

(21) Appl. No.: 19/142,230

(22) PCT Filed: Jan. 12, 2023
(86) PCT No.: PCT/JP2023/000616

§ 371 Date: Jun. 23, 2025

(51) Int. Cl. H04W 74/0808

(52) U.S. Cl. CPC H04W 74/0808

(57) ABSTRACT

When a transmission request occurs, each of the wireless devices performs carrier sensing using the transmission CCA threshold. The wireless device determines whether or not a frame needs to be decoded by using the reception CCA threshold set on the basis of an environment for receiving the frame. A controller sets the reception CCA threshold suitable for each of the wireless devices on the basis of the statistical information received from the wireless device, and notifies the wireless device of the threshold. The reception CCA threshold is set to a value at which each of the wireless devices easily decodes the frame addressed to its own BSS and easily ignores the frame addressed to another BSS, the value providing a desired balance to frame detection areas of a plurality of the wireless devices.

### TECHNICAL FIELD

The present disclosure relates to a CCA threshold determination system, a CCA threshold determination device, a CCA threshold determination method, and a CCA threshold determination program.

### BACKGROUND ART

In the field of wireless communication, a carrier sensing method is widely known as a technology for avoiding communication collision. In this method, a wireless device attempting to start the transmission first checks whether or not a carrier (carrier wave) is transmitted from another device, and starts the transmission processing in a case where the absence of the carrier is confirmed. At this time, whether or not there is the carrier is determined by whether or not the carrier with an intensity exceeding a preset clear channel assessment (CCA) threshold is received.

In recent years, since a large number of wireless devices are densely disposed, it is common that service areas of a plurality of basic service sets (BSSs) overlap. In the IEEE802.11ax standard, a Spatial Reuse (SR) function is added for the purpose of obtaining a high communication quality under such circumstances.

In this function, a BSS color is defined for each BSS. At the time of carrier sensing, a base station and a terminal can identify whether a frame is addressed to its own BSS or addressed to another BSS on the basis of the BSS color included in the received frame. Then, according to this function, the base station and the terminal set the CCA threshold to a default value Tha in a case where the frame is addressed to its own BSS, and change the CCA threshold to an increase value Thb (>Tha) in a case where the frame is addressed to another BSS. Note that in a case where a wireless communication system to be applied is Wi-Fi (registered trademark), the base station corresponds to an access point.

The base station and the terminal can more sensitively detect the presence of a carrier with a lower CCA threshold. Therefore, according to the above-described function, the base station and the terminal detect communication in its own BSS with high sensitivity and detect communication in another BSS with low sensitivity by performing carrier sensing prior to transmission. That is, according to the above-described SR function, the base station and the terminal can perform carrier sensing so as not to unreasonably interfere with communication in its own BSS and not to excessively react to communication in another BSS. Therefore, this function is effective for avoiding a problem of a so-called exposed terminal related to a loss of a transmission opportunity.

### CITATION LIST

### Non Patent Literature

Non Patent Literature 1: IEEE 802.11ax Musen ran ni okeru ko yusen furemu hogo gijutsu no ichi kento (in Japanese) (A Study of Protection Method for Prioritized Frames in OBSS Environment for IEEE 802.11ax Wireless LANs), Otani, and others, IEICE Society Conference, 2021
Non Patent Literature 2: IEEE 802.11ax Musen ran ni okeru ko yusen furemu hogo shuho (in Japanese) (A Protection Method for Prioritized Frames in OBSS Environment for IEEE 802.11ax Wireless LANs), Otani, and others, IEICE General Conference, 2021
Non Patent Literature 3: IEEE 802.11ax Musen ran ni okeru ko yusen furemu soshin sokushin hogo gijutsu (in Japanese) (A Boosting and Protection Method for Prioritized Frames in OBSS Environment for IEEE 802.11ax Wireless LANs), Otani, and others, IEICE General Conference, 2022

### SUMMARY OF INVENTION

### Technical Problem

Non Patent Literatures 1 to 3 disclose a technology for protecting a high-priority frame communication on the premise of the SR function described above. For example, Non Patent Literatures 1 and 2 disclose a technology for changing the CCA threshold from the increase value Thb to a smaller value in a case where the high-priority frame addressed to another BSS is detected at the time of carrier sensing prior to the start of transmission. According to this technology, in addition to the frame in its own BSS, the high-priority frame in another BSS is detected with high sensitivity by performing carrier sensing. As a result, the start of data transmission that collides with the high-priority frame in another BSS is avoided, and thus the high-priority frame is protected.

However, the technologies disclosed in Non Patent Literatures 1 to 3 described above merely relate to threshold setting of the carrier sensing prior to transmission. That is, it relates to a CCA threshold when a wireless device such as a base station or a terminal functions as a transmission station, more specifically, a CCA threshold used by a transmission station in which a transmission request occurs to determine whether or not the transmission can be performed.

For example, the following situation is assumed.
A plurality of terminals and a base station are present in its own BSS.
At least one of a plurality of the terminals is a terminal that transmits a high-priority frame. Hereinafter, the terminal that transmits the high-priority frame is referred to as a “quality of service (QoS) terminal”.
The QoS terminal is also present in another BSS.

By the way, as a normal function, the wireless device that performs carrier sensing ignores a wireless signal with a value less than the CCA threshold regardless of the presence or absence of a transmission request, and receives and decodes the wireless signal with an intensity equal to or greater than the CCA threshold. Assuming that the base station determines the CCA threshold at the time of reception by the methods described in Non Patent Literatures 1 and 2 above on the basis of the above-described assumption, the base station determines the necessity of reception for all the terminals in its own BSS and the QoS terminals in another BSS using the CCA threshold smaller than the increase value Thb, for example, the default value Tha.

In this case, the base station handles all terminals in its own BSS and QoS terminals in another BSS in the same manner with regard to reception. Then, once the base station starts decoding processing of the reception frame, even when the high-priority frame is transmitted from the QoS terminal in its own BSS thereafter, the frame is not received by the base station.

Non Patent Literature 3 discloses that the QoS terminal changes the CCA threshold used at the time of carrier sensing to a value larger than the default value Tha, and that the QoS terminal gives a transmission output larger than a default output to the high-priority frame. According to this technology, it is possible to increase a probability that the QoS terminal obtains a transmission opportunity, and it is possible to increase a probability that the transmission of the high-priority frame is successful. However, when the base station on a side receiving the frame is decoding other reception frames, this transmission is also not be performed.

As described above, the conventional technology that appropriately sets the CCA threshold used by the transmitting station to judge transmission availability in fact improves a communication quality in an environment where the wireless devices are densely located, but it is not capable of controlling the receiving side's state to the desired condition. In order to solve such a problem, for example, it is conceivable to cause the reception CCA threshold to be determined in terms of the reception station in addition to causing the transmission CCA threshold to be determined in terms of the transmission station in the base station or the terminal. That is, when the base station or the terminal is caused to set the reception CCA threshold that makes it easy to receive a frame to be received and makes it easy to ignore other frames according to the environment where the base station or the terminal is located, it is possible to reduce the probability that communication fails due to the problem on the reception side.

On the other hand, when the base station or the terminal independently sets the reception CCA threshold, the balance of the reception CCA threshold among a plurality of the adjacent BSSs may be lost. For example, a problem easily occurs that the CCA thresholds of some base stations become extremely small, and thus the number of terminals accommodated in the cover area of the base station becomes extremely small. Furthermore, the cover areas of a plurality of BSSs largely overlap each other, or conversely, a large gap is generated between the areas, such that a so-called terminal exposure problem or a hidden problem easily occurs.

The present disclosure has been made in view of the above problems, and a first object thereof is to provide a CCA threshold determination system capable of efficiently accommodating a terminal by appropriately avoiding occurrence of a BSS with an extreme service area while causing a wireless device to separately use a transmission CCA threshold used for carrier sensing at the time of transmission and a reception CCA threshold for selecting a reception frame. Note that the reception CCA threshold may be determined and reflected in the transmission CCA threshold. The same applies to other aspects.

Furthermore, a second object of the present disclosure is to provide a CCA threshold determination device capable of efficiently accommodating a terminal by appropriately avoiding occurrence of a BSS with an extreme service area while causing a wireless device to separately use a transmission CCA threshold used for carrier sensing at the time of transmission and a reception CCA threshold for selecting a reception frame.

A third object of the present disclosure is to provide a CCA threshold determination method for efficiently accommodating a terminal by appropriately avoiding occurrence of a BSS with an extreme service area while causing a wireless device to separately use a transmission CCA threshold used for carrier sensing at the time of transmission and a reception CCA threshold for selecting a reception frame.

A fourth object of the present disclosure is to provide a CCA threshold determination program for efficiently accommodating a terminal by appropriately avoiding occurrence of a BSS with an extreme service area while causing a transmission CCA threshold used for carrier sensing at the time of transmission and a reception CCA threshold for selecting a reception frame to be separately used.

### Solution to Problem

According to a first aspect, there is desirably provided a CCA threshold determination system that determines a CCA threshold used in a wireless communication system including a plurality of wireless devices configured by base stations or terminals,
at least two of the wireless devices being configured to execute
processing of performing carrier sensing to determine presence or absence of a frame having a reception power value equal to or greater than a transmission CCA threshold when a transmission request occurs,
processing of transmitting a frame in a case where the absence of the frame having the reception power value equal to or greater than the transmission CCA threshold is confirmed as a result of the carrier sensing, and
processing of ignoring a frame having a reception power value less than the reception CCA threshold and decoding the frame having a reception power value equal to or greater than the reception CCA threshold, and
the CCA threshold determination system comprising a controller that notifies the at least two of the wireless devices of the reception CCA threshold,
in which the controller is configured to execute
processing of, from the at least two of the wireless devices, receiving pieces of statistical information regarding an environment for receiving the frame in the wireless devices,
threshold setting processing of setting the reception CCA threshold suitable for each of the at least two of the wireless devices on a basis of the statistical information, and
processing of notifying the at least two of the wireless devices of the reception CCA thresholds set in the threshold setting processing, and
the threshold setting processing is processing of setting, as the reception CCA threshold, a value at which each of the at least two of the wireless devices easily decodes a frame addressed to its own BSS and easily ignores a frame addressed to another BSS, the value providing a desired balance to frame detection areas of the at least two of the wireless devices.

Furthermore, according to a second aspect, there is desirably provided a CCA threshold determination device that determines a CCA threshold used by a wireless device in a wireless communication system including a plurality of the wireless devices configured by base stations or terminals, the CCA threshold determination device being configured to execute:
processing of receiving pieces of statistical information regarding an environment for receiving a frame in the wireless device from at least two of the wireless devices;
threshold setting processing of setting a reception CCA threshold suitable for each of the at least two of the wireless devices on the basis of the statistical information; and
processing of notifying each of the at least two of the wireless devices of the reception CCA threshold set in the threshold setting processing,
in which the threshold setting processing is processing of setting, as the reception CCA threshold, a value at which each of the at least two of the wireless devices easily decodes a frame addressed to its own BSS and easily ignores a frame addressed to another BSS, the value providing a desired balance to frame detection areas of the at least two of the wireless devices.

Furthermore, according to a third aspect, there is desirably provided a CCA threshold determination method for determining a CCA threshold used in a wireless communication system including a plurality of wireless devices configured by base stations or terminals, the method including:
causing at least two of the wireless devices to execute
processing of performing carrier sensing to determine presence or absence of a frame having a reception power value equal to or greater than a transmission CCA threshold when a transmission request occurs,
processing of transmitting a frame in a case where the absence of the frame having the reception power value equal to or greater than the transmission CCA threshold is confirmed as a result of the carrier sensing, and
processing of ignoring a frame having a reception power value less than the reception CCA threshold and decoding the frame having a reception power value equal to or greater than the reception CCA threshold; and
causing a controller that notifies the at least two of the wireless devices of the reception CCA threshold to execute
processing of, from the at least two of the wireless devices, receiving pieces of statistical information regarding an environment for receiving the frame in the wireless devices,
processing of setting the reception CCA threshold suitable for each of the at least two of the wireless devices on the basis of the statistical information, and
processing of notifying the at least two of the wireless devices of the set reception CCA thresholds,
in which the reception CCA threshold is a value at which each of the at least two of the wireless devices easily decodes a frame addressed to its own BSS and easily ignores a frame addressed to another BSS, the value providing a desired balance to frame detection areas of the at least two of the wireless devices.

Furthermore, according to a fourth aspect, there is desirably provided a CCA threshold determination program for determining a CCA threshold used by a wireless device in a wireless communication system including a plurality of the wireless devices configured by base stations or terminals, the CCA threshold determination program being computer-readable, and causing a controller having a function of exchanging information with at least two of the wireless devices to execute:
processing of receiving pieces of statistical information regarding an environment for receiving a frame in the wireless device from the at least two of the wireless devices;
threshold setting processing of setting a reception CCA threshold suitable for each of the at least two of the wireless devices on the basis of the statistical information; and
processing of notifying each of the at least two of the wireless devices of the reception CCA threshold set in the threshold setting processing,
in which the threshold setting processing is processing of setting, as the reception CCA threshold, a value at which each of the at least two of the wireless devices easily decodes a frame addressed to its own BSS and easily ignores a frame addressed to another BSS, the value providing a desired balance to frame detection areas of the at least two of the wireless devices.

### Advantageous Effects of Invention

According to the first to fourth aspects, by causing the wireless device to use the reception CCA threshold separately from the transmission CCA threshold, high communication quality can be obtained in a dense environment. Furthermore, since the AP controller intensively manages the reception CCA threshold used by each of the wireless devices, it is possible to effectively avoid occurrence of a BSS having an extreme service area.

### BRIEF DESCRIPTION OF DRAWINGS

FIG. 1 is a diagram illustrating an overall configuration of a CCA threshold determination system according to a first embodiment of the present disclosure;

FIG. 2 is a diagram for describing an operation of changing a transmission CCA threshold for determining whether or not an AP 1 illustrated in FIG. 1 can perform transmission;

FIG. 3 is a diagram for describing a problem that occurs in a dense environment illustrated in FIG. 1;

FIG. 4 is a block diagram for describing configurations of an AP controller, an AP, and an STA in the first embodiment of the present disclosure;

FIG. 5 is a block diagram for describing an operation of a MAC unit when an AP illustrated in FIG. 4 functions as a transmission station;

FIG. 6 is a block diagram for describing an operation of a MAC unit when an AP illustrated in FIG. 4 functions as a reception station;

FIG. 7 is a block diagram for describing an operation of a PHY unit when an AP illustrated in FIG. 4 functions as a transmission station;

FIG. 8 is a block diagram for describing an operation of a PHY unit when an AP illustrated in FIG. 4 functions as a reception station;

FIG. 9 is a flowchart for describing a flow of an operation when an AP in the first embodiment of the present disclosure functions as a transmission station;

FIG. 10 is a diagram illustrating a state in which three APs are present under the control of an AP controller in the first embodiment of the present disclosure;

FIG. 11 is a flowchart for describing a flow of processing in which an AP controller in the first embodiment of the present disclosure sets a reception CCA threshold and notifies a subordinate AP of the reception CCA threshold;

FIG. 12 is a diagram for describing a method in which an AP controller in the first embodiment of the present disclosure sets a reception CCA threshold of a subordinate AP;

FIG. 13 is a diagram for describing a fourth example of a method for setting a reception CCA threshold used in the first embodiment of the present disclosure;

FIG. 14 is a diagram for describing a method in which an AP controller in a second embodiment of the present disclosure sets a reception CCA threshold of a subordinate AP;

FIG. 15 is a diagram for describing a method in which an AP controller in a third embodiment of the present disclosure sets a reception CCA threshold of a subordinate AP; and

FIG. 16 is a diagram illustrating a state in which functions of an AP and an STA in the first embodiment of the present disclosure are swapped. Note that although the AP controller is connected to the AP here, the AP controller may be connected to either the STA or the AP in the present disclosure.

### DESCRIPTION OF EMBODIMENTS

### First embodiment

### Basic Configuration of First Embodiment

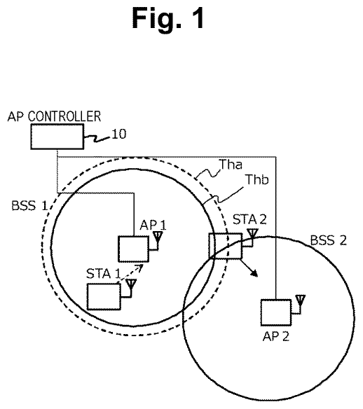

FIG. 1 illustrates an overall configuration of a CCA threshold determination system according to a first embodiment of the present disclosure. More specifically, FIG. 1 illustrates a state in which a plurality of base stations (APs) and a plurality of terminals (STA) are included in two basic service sets (BSSs). Here, it is assumed that an AP 1 and an STA 1 constitute a BSS 1, and an AP 2 and an STA 2 constitute a BSS 2. That is, for the AP 1, the STA 1 is a subordinate terminal belonging to its own BSS, and the STA 2 is a non-subordinate terminal belonging to another BSS.

As illustrated in FIG. 1, the CCA threshold determination system of the present embodiment includes an AP controller 10. The AP controller 10 has a function of controlling a plurality of APs belonging to the AP controller. In the example illustrated in FIG. 1, the AP controller 10 has a function of managing the AP 1 and the AP 2. The AP controller 10 is connected to the AP 1 and the AP 2 in a wired or wireless manner, and can exchange information with each other.

Each of the AP 1 and the AP 2 performs carrier sensing when a data frame transmission request occurs. Both the AP and the STA in the present embodiment include information regarding a BSS color indicating the belonging BSS in a PHY preamble of the transmission frame. Therefore, when the AP 1 detects a frame emitted by the STA 1 through the execution of the carrier sensing, the AP 1 identifies the frame as a frame addressed to its own BSS. Similarly, the AP 1 identifies a frame emitted by the STA 2 as a frame addressed to another BSS.

In FIG. 1, a circle with a broken line centered on the AP 1 schematically indicates a detection area in a case where the transmission CCA threshold of the AP 1 is a default value Tha. Furthermore, a solid-line circle centered on the AP 1 indicates a detection area in a case where the transmission CCA threshold is an increase value Thb.

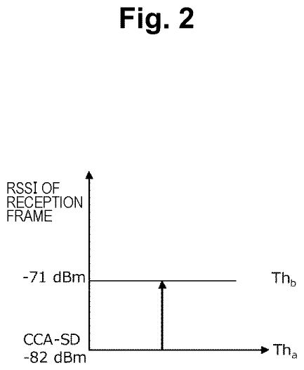

FIG. 2 illustrates a relationship between the default value Tha and the increase value Thb. As illustrated in FIG. 2, the increase value Thb is a value larger than the default value Tha. As the CCA threshold for determining the presence or absence of a carrier is smaller, the sensitivity of the AP 1 increases, and a weak radio wave is detected. Therefore, as illustrated in FIG. 1, the detection area (broken line) based on the default value Tha becomes larger than the detection area (solid line) based on the increase value Thb.

In the present embodiment, the AP 1 sets the transmission CCA threshold to the default value Tha when detecting a frame addressed to its own BSS by performing carrier sensing. As a result, in a case where the frame addressed to its own BSS is transmitted, it is easy to determine that “there is a carrier”, and data collision due to transmission from the AP 1 hardly occurs. On the other hand, in a case where the frame addressed to another BSS is detected by performing carrier sensing, the AP 1 changes the transmission CCA threshold to the increase value Thb. In the example of FIG. 1, as a result, the transmission from the STA 2 is excluded from the detection target, and the transmission is permitted to the AP 1. As described above, in the present embodiment, by appropriately changing and using the transmission CCA threshold, a function of avoiding a collision in its own BSS and a function of avoiding a loss of a transmission opportunity due to communication of another BSS are given to the AP 1.

### Problems to Be Solved by First Embodiment

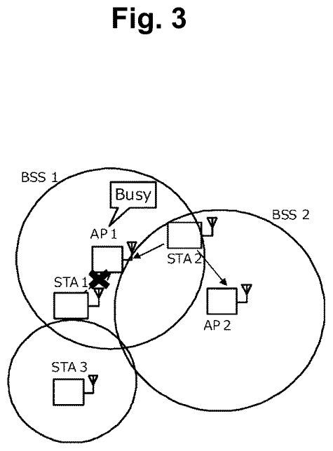

FIG. 3 is a diagram for describing a problem to be further solved in increasing a communication quality using the above-described functions. In a period during which the AP 1 itself does not transmit data, when a frame with an intensity satisfying the CCA threshold is received, the AP 1 starts decoding the frame.

FIGS. 1 and 3 illustrate a state in which only one STA 1 belongs to the BSS 1 for convenience, but a large number of STAs may belong thereto at the same time. In addition, the STA 2 belonging to the BSS 2, which is another BSS, may be present at a position where the distance from the AP 1 is equivalent to that of the STA 1. Therefore, frames emitted by a large number of the STAs may frequently arrive at the AP 1. In this case, even in a case where the STA 1 transmits a high-priority frame, when the AP 1 is busy decoding the signal from another STA, the high-priority frame may not be received by the AP 1.

Thus, in the present embodiment, each AP is caused to use the reception CCA threshold separately from the transmission CCA threshold for avoiding collision of own transmission with other communication. Furthermore, the reception CCA threshold is set to a value at which a frame in its own BSS is likely to be preferentially received. Thus, in the present embodiment, the probability that the transmission frame is not received due to the state on the reception side, that is, the probability of communication failure indicated by a cross mark in FIG. 3 is decreased.

Meanwhile, in the example illustrated in FIG. 3, an AP 3 is illustrated in addition to the AP 1 and the AP 2. Furthermore, FIG. 3 illustrates a state in which the AP 3 sets an extremely small detection area while avoiding overlapping of the detection area with the AP 2. In a case where a plurality of APs disposed adjacent to each other separately and independently sets their own reception CCA thresholds, the detection areas of some APs may become extremely small as illustrated in FIG. 3. Then, when such a detection area is set, some of the APs do not cover any of the STAs, and the communication efficiency of the entire system may be decreased.

Thus, in the present embodiment, the reception CCA threshold used by each AP is intensively managed by the AP controller 10 illustrated in FIG. 1. That is, the AP controller 10 is caused to collectively set the reception CCA threshold to be used by all the subordinate APs such that all the subordinate APs have appropriate detection areas.

### Detailed Configuration of First Embodiment

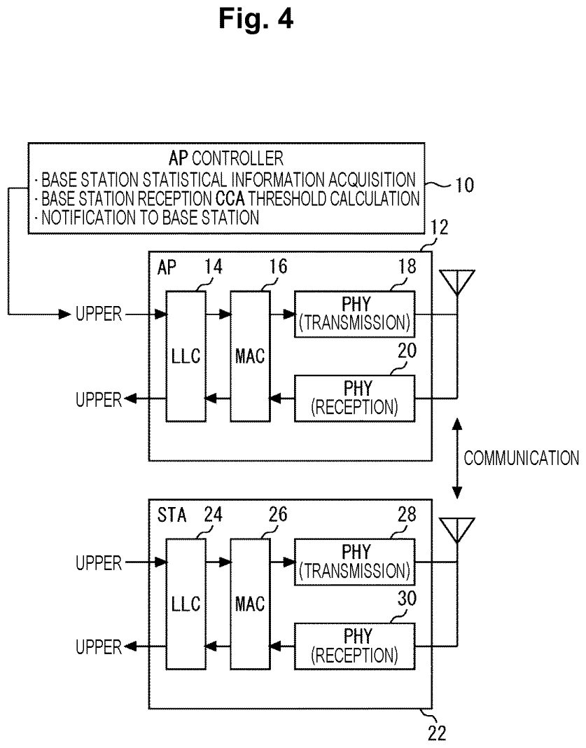

FIG. 4 is a block diagram for describing configurations of the AP controller 10, an AP 12, and an STA 22 in the first embodiment of the present disclosure. It is assumed that the AP controller 10, the AP 1 and AP 2, and the STA 1 and STA 2, which are illustrated in FIG. 1, have a configuration to be described below. Specifically, this configuration is made by combining dedicated hardware with a CPU, a memory device, and various input/output interfaces. Furthermore, the memory device stores a program to be executed by the CPU. The various functions to be described later are implemented by the CPU performing processing in accordance with the above-described program.

As illustrated in FIG. 4, the CCA threshold determination system of the present embodiment includes the AP controller 10. The AP controller 10 mainly performs the following processing.
Acquire statistical information regarding a subordinate AP. The statistical information includes a transmission source of a reception frame, a destination of the reception frame, a frequency of a high-priority frame (hereinafter, referred to as a “QoS frame”), and a frame length.
Calculation of a reception CCA threshold of each subordinate AP.
Notification of a reception CCA threshold to each subordinate AP.

The AP 12 transmits input data from an upper layer including the AP controller 10 as a wireless signal through a logical link control (LLC) unit 14, a medium access control (MAC) unit 16, and a physical (PHY) transmission unit 18. Furthermore, the AP 12 provides the received wireless signal to the upper layer through a PHY reception unit 20, a MAC unit 16, and an LLC unit 14. Similarly, the STA 22 also transmits and receives data through an LLC unit 24, a MAC unit 26, a PHY transmission unit 28, and a PHY reception unit 30.

The LLC units 14 and 24 have a role as an interface with an upper layer. In a case where data is input from the upper layer, a header such as DSAP or SSAP is added thereto. Furthermore, in a case where the data is input from the MAC units 16 and 26, the LLC units 14 and 24 delete the header and provide the data to the upper layer. In a case where the information regarding a frame counter is notified from the AP controller 10, the information is input to the upper layer.

When packets are input from the LLC units 14 and 24, the MAC units 16 and 26 assign MAC headers including a transmission destination address, a transmission source address, a sequence number, a TID, and an error detection code to the packets. Furthermore, prior to data transmission, whether or not transmission is possible is determined by a CSMA/CA method on the basis of the power of signals received by the PHY reception units 20 and 30. At the time of determining whether or not transmission can be performed, a threshold may be controlled on the basis of a BSS Color that is belonging information of the received BSS or a QoS Color that is priority information of a frame. Alternatively, these pieces of information are received from the AP controller 10. Furthermore, in a case where a high-priority QoS frame is transmitted, count processing on the number of times of transmission and the total traffic amount of the frame is performed. When packets are input from the PHY reception units 20 and 30, the MAC units 16 and 26 demodulate the MAC headers included in the packets. Then, in a case where the packets are data addressed to their own station, processing of outputting the packets toward the LLC units 14 and 24 is performed.

When receiving an input of frames from the MAC units 16 and 26, the PHY transmission units 18 and 28 add a PHY header, a preamble, and the like to the frames, and then transmit the frames as a wireless signal. The preamble includes a BSS color and a QoS color. In particular, the latter may be assigned with reference to TID information or the like of the MAC header.

When receiving the wireless signal, the PHY reception units 20 and 30 demodulate the PHY header, the preamble, and the like included in the signal. At this time, simultaneously with the demodulation, the BSS color and the QoS color described in the preamble may be identified and input to the MAC units 16 and 26 together with the payload.

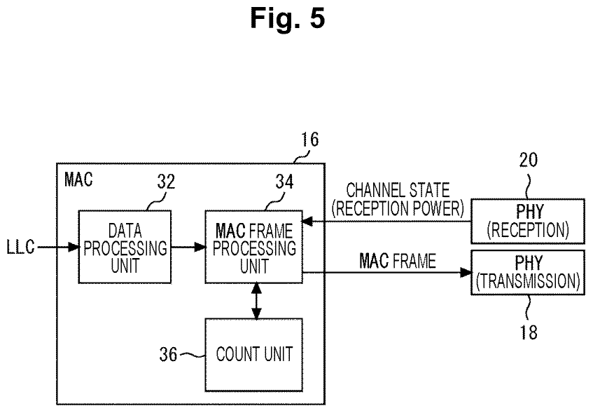

FIG. 5 is a block diagram for describing the operation of the MAC unit 16 when the AP 12 functions as the transmission station. Here, in a data processing unit 32, the MAC header is attached to the data input from the LLC unit 14. In the MAC header, information such as a transmission destination address and a TID indicating priority of data is written. The data processed by the data processing unit 32 is input to a MAC frame processing unit 34.

The MAC frame processing unit 34 determines whether or not transmission can be performed by the CSMA/CA method on the basis of the reception power input from the PHY reception unit 20. Specifically, carrier sensing is performed for a randomly set time, and it is determined that transmission is possible when the idle state of the channel can be confirmed. When this determination is made, the MAC frame processing unit 34 inputs the transmission data to the PHY transmission unit 18.

The transmission CCA threshold used for carrier sensing may be determined according to a combination of the BSS color and the QoS color. Furthermore, the transmission information of the QoS frame and the selection information of the CCA threshold, which are used in the MAC frame processing unit 34, are input to a count unit 36. The count unit 36 counts the number of times of transmission of the QoS frame and the total extension of the QoS frame on the basis of the information of the QoS frame input in this manner. The AP controller 10 is notified of a value counted by the count unit 36.

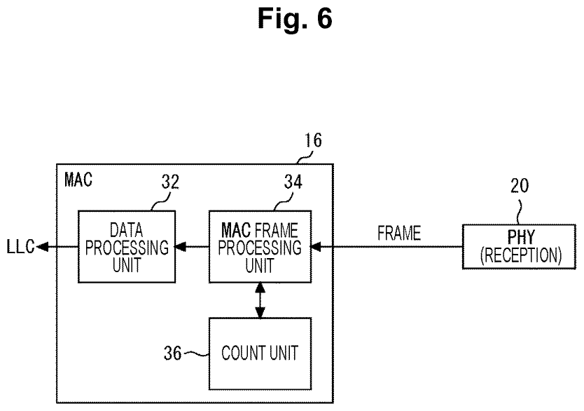

FIG. 6 is a block diagram for describing the operation of the MAC unit 16 when the AP 12 functions as the reception station. A frame to be addressed to its own BSS, which is detected by the PHY reception unit 20, is input to the MAC frame processing unit 34.

The data processing unit 32 extracts data with reference to the MAC header of the input frame and inputs the data to the LLC unit 14.

The transmission information of the QoS frame, information regarding a reception power value, selection information of a CCA threshold, and the like, which are used in the MAC frame processing unit 34, are input to the count unit 36, and used for counting of the QoS frame. Furthermore, the AP controller 10 is notified of the value counted here.

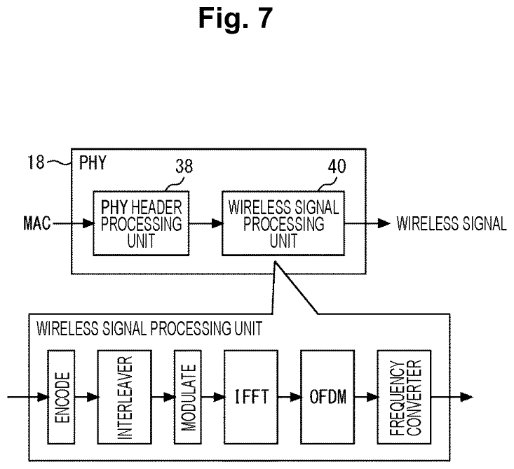

FIG. 7 is a block diagram for describing the operation of the PHY unit 18 when the AP 12 illustrated in FIG. 4 functions as the transmission station. Here, in particular, the operation of the PHY unit 18 when the AP 12 transmits a frame to which the QoS color indicating a high priority is added together with the BSS color will be described.

The PHY unit 18 includes a PHY header processing unit 38. The PHY header processing unit 38 assigns the PHY header to the data input from the MAC unit 16. The PHY header can include information such as the BSS color and the QoS color. The values of the BSS color and QoS color are determined on the basis of the BSS information and the TID information included in the MAC header.

The data to which the PHY header is added in the PHY header processing unit 38 is input to a wireless signal processing unit 40. The wireless signal processing unit 40 performs the processing illustrated in the lower portion of FIG. 7 on the input frame to generate a wireless signal. The PHY unit 18 transmits the wireless signal generated in this manner.

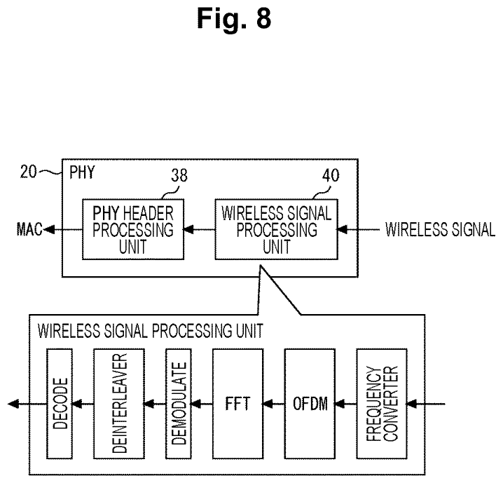

FIG. 8 is a block diagram for describing the operation of the PHY unit 20 when the AP 12 illustrated in FIG. 4 functions as the reception station. Here, in particular, the operation of the PHY unit 20 when the AP 12 receives a frame to which the QoS color is added together with the BSS color will be described.

The PHY unit 20 receives the wireless signal by performing the carrier sensing and also receives the wireless signal when the carrier sensing is not performed. In any case, when detecting the wireless signal, the wireless signal processing unit 40 decodes the radio signal by the processing illustrated in the lower portion of FIG. 8. The frame obtained as the result of this is output to the PHY header processing unit 38.

At this time, the PHY header processing unit 38 identifies information included in the PHY header of the input frame. In particular, the operation will be performed below on the basis of information regarding the BSS color and QoS color included in the PHY header.

### At Time of Frame Reception (At Time of Non-Carrier Sensing)

In a case where the BSS colors match, that is, in a case where the reception frame is addressed to its own BSS, the demodulation processing is continuously performed. On the other hand, in a case where the BSS colors do not match, the demodulation operation stops. However, in either case, the MAC unit 16 is notified of the information regarding the BSS color and QoS color. Furthermore, in the present embodiment, as described later, the reception CCA threshold is determined on the basis of a combination of the BSS color and the QoS color. At the time of frame reception, the MAC unit 16 is also notified of the value.

### At Time of Carrier Sensing (At Time of Frame Transmission)

In the present embodiment, the transmission CCA threshold used at the time of carrier sensing is determined on the basis of the BSS color. In a case where a wireless signal is received by performing carrier sensing, the MAC unit 16 is also notified of the determined transmission CCA threshold.

### Operation of First Embodiment

### Carrier Sensing

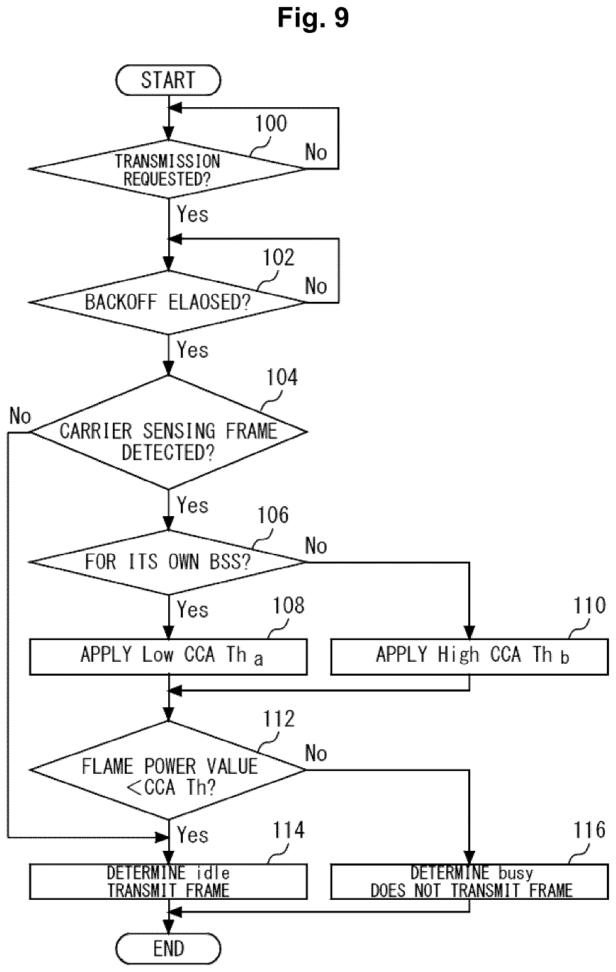

FIG. 9 is a flowchart for describing a flow of the operation when the AP 12 in the present embodiment functions as the transmission station. In the routine illustrated in FIG. 9, first, it is determined whether or not the transmission request occurs in the AP 12 (step 100).

When the generation of the transmission request is recognized, next, it is determined whether or not a randomly set backoff has elapsed (step 102). The backoff is a waiting time before the start of carrier sensing.

When it is determined that backoff has elapsed, the carrier sensing is started. Specifically, first, it is determined whether or not any carrier sensing frame emitted by another wireless device is detected (step 104).

When no carrier sensing frame is detected, it can be determined that a channel is clear at that time. In this case, the processing of step 114 to be described later is immediately executed. On the other hand, in a case where a carrier sensing frame is detected, it is determined whether or not the destination of the frame belongs to its own BSS on the basis of the BSS color included in the header information (step 106).

In a case where it is determined that the destination belongs to its own BSS, the default value Tha is applied as the transmission CCA threshold used for PHY preamble detection (step 108). As described above, the default value Tha is a small value for setting the sensitivity of carrier sensing to be high.

On the other hand, in a case where it is determined that the destination does not belong to its own BSS, the increase value Thb is applied as the transmission CCA threshold used (step 110). The increase value Thb is a value larger than the default value Tha. Therefore, in a case where the increase value Thb is applied, the Sensitivity of carrier sensing is lower than that in a case where the default value Tha is set.

When the above-described processing ends, next, it is determined whether or not the reception power value of the detected frame is smaller than the transmission CCA threshold (step 112).

As a result, in a case where it is determined that the frame power value is smaller than the transmission CCA threshold, it can be determined that the channel is clear. In this case, idle determination is made, and frame transmission by the AP 12 is permitted (step 114).

On the other hand, in step 112, in a case where it is determined that the frame power is not smaller than the transmission CCA threshold, it can be determined that the channel is not clear. In this case, a busy determination is made, and the AP 12 does not perform the frame transmission at the current time point (step 116).

According to the above-described processing, the AP 12 makes the busy determination with high sensitivity for the frame addressed to its own BSS. Therefore, communication in its own BSS can be effectively protected. Furthermore, the AP 12 makes the busy determination with low sensitivity for the frame addressed to another BSS. Therefore, the AP 12 can obtain a transmission opportunity with an appropriate frequency without excessively reacting to communication of another BSS even in an environment where the wireless devices are dense.

### Frame Reception

In the present embodiment, the AP 12 differentiates and sets the CCA thresholds determined by the SR function defined in the IEEE802.11ax standard between the transmission side and the reception side. The reception CCA threshold is determined for each AP 12 on the basis of a reception power value from a specific terminal among subordinate terminals present in its own BSS or a reception power value from other BSS terminals present in another BSS. In particular, in the present embodiment, the reception CCA threshold is not determined by each AP but by the AP controller 10 such that cooperation between a plurality of APs can be obtained. Note that the specific terminal will be described in detail later.

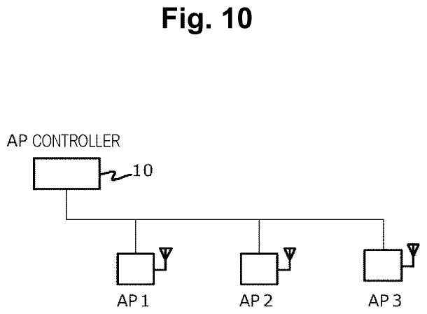

FIG. 10 illustrates a situation in which three APs are present under the control of the AP controller 10. As illustrated in FIG. 10, in the present embodiment, the AP controller 10 connected to the APs 1 to 3 is disposed. The AP controller 10 collects information such as the arrangement of STAs or QoS terminals present under the control of each of the APs 1 to 3, the number of transmission frames, the transmission air time of the QoS frame, and the terminal density, and determines the reception CCA threshold on the basis of the information. Furthermore, the AP controller 10 notifies the corresponding AP of the reception CCA threshold determined for each AP.

Moreover, when an overlap is recognized between a plurality of BSSs, the AP controller 10 sets the reception CCA threshold such that the overlap is eliminated. For example, the sensitivity of the reception CCA threshold can be set such that a frame from the STA located at a midpoint of the overlapping detection area is received. Alternatively, the reception CCA threshold of each of a plurality of the APs may be set at a ratio that can ensure fairness on the basis of the information collected by the AP controller 10. Moreover, the time during which each AP uses the reception CCA threshold optimal for AP itself may be allocated according to the ratio. Furthermore, the reception CCA threshold may be determined such that the number of STAs that can be covered by the entire system is maximized. Furthermore, the reception CCA threshold may be associated with the QoS Color, or a common reception CCA threshold may be set for a plurality of the APs.

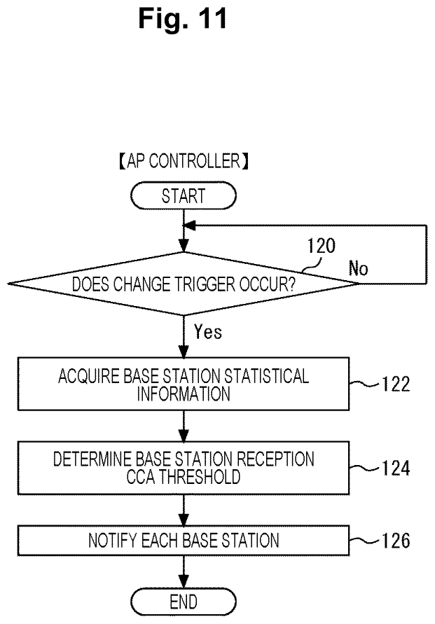

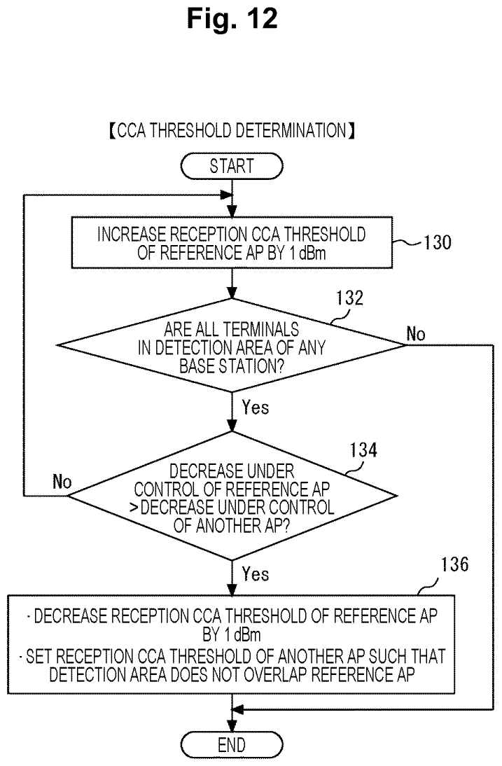

Hereinafter, processing in which the AP controller 10 sets the reception CCA threshold and notifies each AP of the reception CCA threshold will be specifically described with reference to FIGS. 11 and 12.

FIG. 11 is a flowchart for describing a flow of the processing executed by the AP controller 10 to set the reception CCA threshold used by the subordinate APs 1 to 3 in the present embodiment. Similarly to the AP 12, the APs 1 to 3 set the transmission CCA threshold by the routine illustrated in FIG. 9. The transmission CCA threshold is used only when the AP performs carrier sensing. During a period in which the carrier sensing is not performed, the APs 1 to 3 determine whether or not to start decoding the reception frame by using the reception CCA threshold notified by the routine illustrated in FIG. 11.

In the routine illustrated in FIG. 11, first, it is determined whether or not a trigger to change the reception CCA threshold occurs (step 120). In the present embodiment, the reception CCA threshold of each AP is set on the basis of the reception power value from the specific terminal present around each AP. Therefore, in any AP, in a case where the position of the specific terminal or the reception power value from the specific terminal greatly changes, it is necessary to newly set the reception CCA threshold again. Specifically, in this step 120, in any AP, it is determined whether or not a change exceeding a predetermined determination value occurs in the position of the specific terminal or the reception power value from the specific terminal.

When the above-described change is recognized, next, statistical information regarding an environment for receiving the frame is acquired from each of the subordinate APs (step 122). The statistical information includes the transmission source of the frame reaching the AP and information regarding each frame. More specifically, the following information distinguished for each STA of the transmission source is included.
BSS color for identifying destination BSS
Reception power value
Transmission frequency of QoS frame
Air time of QoS frame

The AP controller 10 determines the specific terminal for each subordinate AP on the basis of these pieces of the statistical information.

Next, the AP controller 10 determines the reception CCA threshold for each subordinate AP on the basis of the statistical information (step 124). Specifically, first, the specific terminal for each subordinate AP is determined on the basis of the statistical information. For example, the specific terminal is determined as any one of the following STAs.
(1) One of QoS terminals under the control of the AP If there is a significant variation in the received power values among QoS terminals, the terminal with the smallest received power value among the QoS terminals may be selected.
(2) An STA present at a farthest position among STAs under the control of the AP. Note that the STA notifies the AP of its own position information.
(3) An STA that transmits the QoS frames the most during a certain period among STAs under the control of the base station.
(4) An STA that has the longest transmission air time of the QoS frame among STAs under the control of the base station.

Next, for each subordinate AP, the reception power value from the specific terminal is specified as the environment for receiving the frame in the AP. For example, in a case where (1) above is adopted, for each of the APs 1 to 3, one of the subordinate QoS terminals is set as the specific terminal, and the reception power values A1 to A3 from these QoS terminals are set as the reception CCA thresholds of the APs 1 to 3. As a result, in the APs 1 to 3, the reception power values A1 to A3 from the specific terminals become the minimum values satisfying the decoding condition. Note that the reception CCA threshold is not limited to the reception power values A1 to A3, and may be a value obtained by adding or subtracting a margin value α to or from each of the reception power values A1 to A3.

In a case where the specific terminal is set according to (1) above, the reception CCA threshold of each AP is set to a value that decodes the frame from the subordinate QoS terminal with high probability and ignores a frame lower in level than the frame. In this case, the probability that the AP 12 becomes busy by decoding the frame with low priority decreases. As a result, the probability that the AP 12 receives the QoS frame from its own BSS can be increased.

In a case where the specific terminal is set according to (2) above, the reception CCA threshold of each AP is set to a value that decodes the frame from all the subordinate STAs with high probability and ignores a frame lower in level than the frame. In this case, the probability that the AP 12 starts decoding the frame from another BSS terminal located at a position farther than the specific terminal decreases. As a result, the probability that the AP 12 receives the frame from the STA in its own BSS can be increased.

In a case where the specific terminal is set according to (3) above, the reception CCA threshold of each AP is set to a value that decodes the frame from the QoS terminal that emits the QoS frame most frequently with high probability and ignores a frame lower in level than the frame. In this case, the probability that the AP 12 receives the frame from the QoS terminal can be increased, and the success probability of the QoS frame in its own BSS can be increased.

In a case where the specific terminal is set according to (4) above, the reception CCA threshold of each AP is set to a value that decodes the frame from the QoS terminal having the longest transmission air time with high probability and ignores a frame lower in level than the frame. In this case, the probability that the AP 12 receives the frame from the QoS terminal can be increased, and the success probability of the QoS frame in its own BSS can be increased.

When the reception CCA threshold is provisionally determined for each subordinate AP by the above-described processing, next, in step 124, processing of finally determining the reception CCA threshold for each AP is executed by a method to be described later with reference to FIG. 12. In this processing, correction for coordinating all the reception CCA thresholds provisionally determined for each AP is performed such that the detection area set for each of the APs 1 to 3 does not become extreme.

When the above-described processing ends, the reception CCA threshold determined for each AP is notified from the AP controller 10 to each subordinate AP (step 126).

FIG. 12 is a flowchart for describing a flow of processing in which the AP controller 10 corrects the provisionally determined reception CCA threshold and finally determines the reception CCA threshold, in step 124. Here, first, a reference AP is determined from among a plurality of APs under the control of the AP controller 10 (step 130). The reference AP can be determined on the basis of the statistical information of the QoS terminal. For example, an AP having the maximum number of subordinate QoS terminals may be used as the reference AP. The reference AP may be reselected at regular time intervals or may be sequentially selected according to a certain rule. When the reference AP is determined, next, the reception CCA threshold provisionally determined for the AP is increased by a specified value (for example, 1 dBm) . Thus, the detection area of the reference AP is slightly narrowed. Note that the upper limit of the CCA threshold may be set in advance for each AP, and the CCA threshold may not be increased in a range exceeding the upper limit.

After the above-described processing ends, next, it is determined whether or not all the STAs associated with the APs under the control of the AP controller 10 are located within the detection area of any AP (step 132). As a result, when a situation occurs in which any of the STAs does not belong to the detection area of any of the APs, the correction for the reception CCA threshold is stopped, and the reception CCA threshold at the start of this routine is determined as a final determination value. Note that the processing in step 132 may be omitted.

When it is determined by the processing in step 132 that all the STAs are within the detection area of any AP, next, it is determined whether or not the decrease number of STAs under the control of the reference AP is larger than the decrease number of STAs under the control of the other APs (step 134). For example, when one STA under the control of the reference AP and two STAs under the control of other APs disappear from the detection area of the reference AP due to the change in step 130, the ratio of subordinate STAs in the detection area of the reference AP increases. In this case, the determination in step 134 is negative, the processing in step 130 is executed again. As a result, the detection area of the reference AP is further narrowed.

On the other hand, for example, when only one STA under the control of the reference AP disappears from the detection area of the reference AP and no STA under the control of other APs disappears from the detection area of the reference AP due to the change in step 130, the ratio of subordinate STAs in the detection area of the reference AP decreases. In this case, the determination in step 134 is positive, and the reception CCA threshold of the reference AP is decreased by a specified value (for example, 1 dBm) (step 136). That is, in a case where the ratio of the subordinate STAs in the detection area of the reference AP decreases due to the change in step 130, the reception CCA threshold of the reference AP is returned to the value before the change in step 130 by the processing in step 136.

In step 136, the reception CCA threshold of another AP is further set such that the detection area of another AP does not interfere with the detection area of the reference AP. Specifically, the reception CCA threshold of another AP is set such that two detection areas do not overlap. Alternatively, the reception CCA threshold of another AP is set such that the midpoint between the reference AP and another AP becomes the limit point of the detection area.

According to the above-described processing, in a case where a plurality of the APs are adjacent to each other, it is possible to cause each AP to use the reception CCA threshold corresponding to the environment for receiving the frame surrounding each AP, separately from the transmission CCA threshold. Therefore, in the CCA threshold determination system of the present embodiment, it is possible to effectively decrease the possibility that communication of a specific frame fails due to state on the reception side.

Moreover, according to the above-described processing, a plurality of the APs can be caused to use the reception CCA threshold individually set by the AP controller 10 in consideration of the overall balance. Therefore, it is possible to prevent only some APs from setting the extremely narrow detection area. As a result, in the CCA threshold determination system of the present embodiment, high communication efficiency can be achieved in the entire system including a plurality of the APs.

### Modification Example of First Embodiment

### Provisionally Determined Value of Reception CCA Threshold

Meanwhile, in the first embodiment described above, the reception CCA threshold is changed in a case where the occurrence of the change trigger is recognized, but the present disclosure is not limited thereto. For example, the position of the specific terminal described above may be continuously detected, and the provisionally determined value of the reception CCA threshold of each AP may be changed following the position of the specific terminal. The same applies to other embodiments to be described below.

### Second Example of Method for Setting Provisionally Determined Value of Reception CCA Threshold

In the first embodiment described above, the provisionally determined value of the reception CCA threshold for each AP is set on the basis of the reception power value A from the specific terminal in its own BSS. However, a setting method is not limited to this. Hereinafter, features of the second example of the setting method will be described.

In the second example, in step 124 illustrated in FIG. 11, the specific terminal for each AP is determined as the specific STA in another BSS, rather than the STA in its own BSS. Specifically, in the second example, for each AP, any one of the STAs below is set as the specific terminal.
(1) An STA present at the closest position among STAs in another BSS present around the AP. Note that the STA notifies the AP of its own position information.
(2) An STA that transmits the QoS frames or normal frames the most during a certain period among STAs in another BSS present around the AP.
(3) An STA that has the longest transmission air time of the QoS frame or the normal frame among STAs in another BSS present around the AP.

In the second example, in step 124 illustrated in FIG. 11, a value “B+α” obtained by adding a margin value a to a reception power value B from the specific terminal in another BSS is set as the reception CCA threshold. That is, the reception CCA threshold is determined such that the reception power value B from the specific terminal becomes the maximum value that does not satisfy the decoding condition.

In a case where the specific terminal is set according to (1) above, the reception CCA threshold of each AP is set to a value that ignores the frame from another BSS terminal which is the closest with high probability and decodes a frame higher in level than the frame. In this case, the probability that the AP 12 becomes busy by decoding the frame from another BSS terminal decreases. A a result, the probability that the AP 12 receives the frame from its own BSS can be increased.

In a case where the specific terminal is set according to (2) above, the reception CCA threshold of each AP is set to a value that ignores the frame from another BSS terminal that emits the frame the most frequently with high probability and decodes a frame higher in level than the frame. In this case, the probability that the AP 12 becomes busy due to the frame from another BSS terminal decreases. As a result, the probability that the AP 12 receives the frame from its own BSS can be increased.

In a case where the specific terminal is set according to (3) above, the reception CCA threshold of each AP is set to a value that ignores the frame from another BSS terminal having the longest transmission air time with high probability and decodes a frame higher in level than the frame. In this case, similarly to the case of (2) above, the probability that the AP 12 receives the frame from its own BSS can be increased.

### Third Example of Method for Setting Provisionally Determined Value of Reception CCA Threshold

Next, a third example of a method for setting a provisionally determined value of a reception CCA threshold for each AP will be described. In the third example, in step 124 illustrated in FIG. 11, for each AP, one of the STAs in its own BSS is specified as a first specific terminal, and one of other BSS terminals is specified as a second specific terminal. Furthermore, in step 124, both the reception power value A of the first specific terminal and the reception power value B of the second specific terminal are measured. Note that the first specific terminal may be determined by any of the methods (1) to (4) described in the first embodiment. Furthermore, the second specific terminal may be determined by any of the methods (1) to (3) described in the second example.

In the present embodiment, in step 124 illustrated in FIG. 11, the reception CCA threshold is set as follows on the basis of the comparison between the reception power value A of the first specific terminal and the reception power value B of the second specific terminal.
(1) In a case of A≤B: Reception CCA threshold=A
(2) In a case of A>B: Reception CCA threshold=B+α

In any of (1) and (2) above, the reception CCA threshold is set to a value that ignores the frame from the specific terminal in another BSS and decodes the frame higher in level than the frame. In this case, the probability that the AP becomes busy by decoding the frame from another BSS terminal decreases. As a result, the probability that the AP receives the frame from its own BSS can be increased.

### Fourth Example of Method for Setting Provisionally Determined Value of Reception CCA Threshold

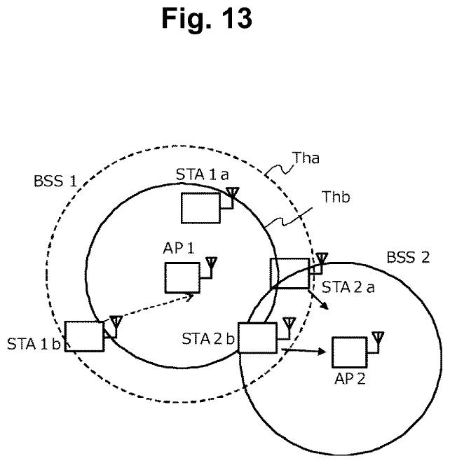

Next, with reference to FIG. 13, a fourth example of a method for setting a provisionally determined value of a reception CCA threshold will be described. In the fourth example, the reception CCA threshold of each AP is determined by a method to described below.

FIG. 13 is a diagram for describing a method in which the AP sets the reception CCA threshold in the fourth example. In FIG. 13, a circle with a broken line centered on the AP 1 indicates a detection area in a case where a search purpose CCA threshold is set to a default value Tha. Furthermore, a solid-line circle centered on the AP 1 indicates a detection area in a case where an increase value Thb larger than the default value Tha is set as the search purpose CCA threshold.

In the example illustrated in FIG. 13, in a case where the AP 1 sets the default value Tha to the search purpose CCA threshold, two own BSS terminals (STA 1a and STA 1b) and two other BSS terminals (STA 2a and STA 2b) are included in the detection area. Then, when the search purpose CCA threshold is changed from the default value Tha to the increase value Thb, one own BSS (STA 1b) and two other BSS terminals (STA 2a and STA 2b) are outside the detection area, and only STA 1a that is the own BSS remains as the detection target.

As described above, when the CCA threshold of the AP 1 is increased or decreased, the number of its own BSS terminals and the number of other BSS terminals, which are located in the detection area, are individually changed according to the change of the CCA threshold. Then, in an environment where a large number of its own BSS terminals and a large number of other BSS terminals are densely present, when the CCA threshold is continuously changed such that a larger number of other BSS terminals than its own BSS terminals are outside the detection area, the ratio of the own BSS terminals remaining in the detection area can be finally maximized.

In order to increase the probability that the AP 1 receives a frame in its own BSS without being disturbed by frames from other BSS terminals, it is desirable that the ratio of its own BSS terminals included in the detection area of the AP 1 is higher. Therefore, in the fourth example, the reception CCA threshold is determined for each AP by the following method in order to meet the above-described request.
(S1) For each AP, the search purpose CCA threshold is set to an initial value (for example, Tha).
(S2) For each AP, the number of its own BSS terminals and the number of other BSS terminals, from which a frame can be received, are measured.
(S3) For each AP, the search purpose CCA threshold is increased by ΔTh dBm to detect the number N1 of its own BSS terminals that cannot be detected and the number N2 of other BSS terminals that cannot be detected.
(S4) For each AP, (S2) and (S3) above are repeated while the decreasing number N1 of its own BSS terminals is smaller than the decreasing number N2 of other BSS terminals.
(S5) For each AP, the search purpose CCA threshold (Tha+n*ΔTh) at the limit point where N1<N2 holds is determined as the reception CCA threshold.

According to the above-described method, for each AP, the reception CCA threshold can be set such that the ratio of its own BSS terminals in the detection area is maximized. Therefore, according to the method of the fourth example, similarly to the first to third examples, it is possible to cause each AP to preferentially receive the frame from its own BSS terminal with the high probability.

Note that, in the above-described example, the search purpose CCA threshold for the limit point satisfying N1<N2 is determined as the reception CCA threshold, but the method for maximizing the ratio of terminals in its own BSS is not limited thereto. For example, the search purpose CCA threshold may be changed from the upper limit to the lower limit, which are settable, and the search purpose CCA threshold that maximizes the ratio of terminals in its own BSS may be found on the basis of the result.

### Modification Example Regarding Use of Reception CCA Threshold

In the first embodiment described above, the reception CCA threshold is always set separately from the transmission CCA threshold without considering the communication environment. However, the present disclosure is not limited thereto. For example, for each AP, the operations in the first embodiment may be performed only under a situation where communication is congested on the basis of the total traffic amount generated under the control of the AP or the traffic ratio of the QoS frames. That is, the processing of setting the reception CCA threshold again is not executed in a case where the total traffic amount or the like is equal to or less than a certain threshold, and the processing of setting the reception CCA threshold again may be executed only in a case where the total traffic amount or the like exceeds the predetermined threshold.

Furthermore, in any of the first embodiment and the second to fourth examples described above, a margin may be added to the reception CCA threshold according to the variation in the reception power from the STA as a reference. In this case, the maximum value of the variation in the reception power may be used as the margin, or the average value of the variations may be added as the margin. Moreover, a range in which the reception CCA threshold can be acquired may be specified in advance.

### Modification Example Regarding Decrease Number Count in Step 134

Furthermore, in the above-described first embodiment, in step 134 illustrated in FIG. 12, the decrease number of STAs under the control of the reference AP and the decrease number of STAs under the control of another AP are counted by real numbers. However, the present disclosure is not limited thereto. For example, from the viewpoint that the number of QoS terminals belonging to each AP is important, the number of QoS terminals may be weighted to calculate the above-described decrease number.

### Second Embodiment

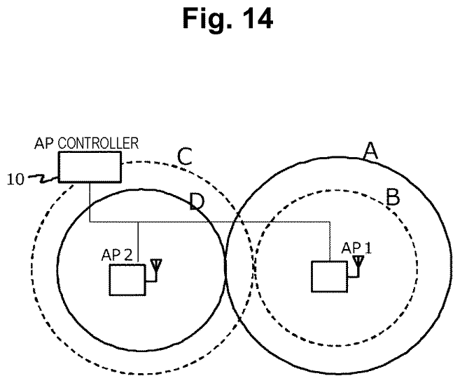

Next, a second embodiment of the present disclosure will be described with reference to FIG. 14. A CCA threshold determination system according to the present embodiment is similar to the CCA threshold determination system according to the first embodiment except that the AP controller 10 uses, as a method for determining the reception CCA threshold for each subordinate AP, a method to be described below instead of the method described above with reference to FIGS. 11 and 12.

FIG. 14 illustrates an example in which the AP controller 10 sets the reception CCA thresholds of the AP 1 and the AP 2 to values corresponding to “A” and “B” indicated by solid circles, respectively. “A” and “B” specifically mean the radius of the detection area of the AP 1 and the radius of the detection area of AP 2.

In the present embodiment, the AP controller 10 determines the reception CCA threshold of each subordinate AP according to the number of STAs belonging to each AP. That is, in the example illustrated in FIG. 14, the AP controller 10 sets these reception CCA thresholds such that the ratio of the number N1 of STAs under AP1 to the number N2 of STAs under AP2 becomes A:B, and A+B matches the distance from the AP 1 to the AP 2.

According to such a reception CCA threshold, it is possible to cause each of the AP 1 and the AP 2 to execute the reception processing with appropriate sensitivity while avoiding occurrence of a so-called exposed terminal problem due to overlapping of the detection range of the AP 1 and the detection range of the AP 2. Therefore, in the CCA threshold determination system of the present embodiment, it is possible to create a better communication environment for the entire system as in the first embodiment.

Note that, in the second embodiment described above, the number of STAs under the control of the AP is used as the basis of the reception CCA threshold, but a value that can be obtained as the basis is not limited to “the number of subordinate STAS”. For example, the number of QoS terminals under the control of the AP, the frequency or air time of QoS frames generated under the control of the AP, or the like may be replaced with “the number of subordinate STAs” and used.

### Third embodiment

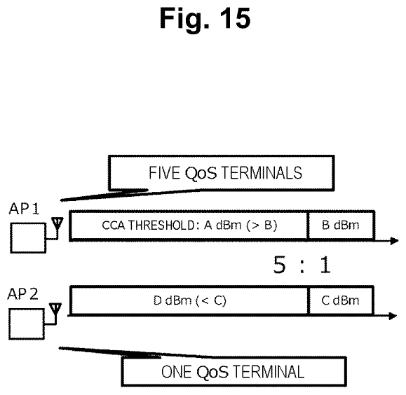

Next, a third embodiment of the present disclosure will be described with reference to FIG. 15. In the present embodiment, as in the first embodiment, the AP controller 10 provisionally determines the reception CCA threshold for each of the subordinate APs by the method described with reference to FIG. 11. The CCA threshold determination system of the present embodiment is similar to the configuration in the first embodiment except that how to cause each AP to use the provisionally determined reception CCA threshold is different.

FIG. 15 is a diagram for describing how to notify each subordinate AP of the reception CCA threshold provisionally determined by the AP controller 10 in the present embodiment. In FIG. 15, a horizontal axis with a rightward arrow indicates a time axis. The example illustrated in FIG. 15 specifically illustrates the following events.
There are five QoS terminals under the control of the AP 1, and there is only one QoS terminal under the control of the AP 2.
In an initial setting, the reception CCA threshold of the AP 1 is set to “A” dBm, and the reception CCA threshold of the AP 2 is set to “D” dBm.
In a later setting, the reception CCA threshold of the AP 1 is set to “B” dBm, and the reception CCA threshold of the AP 2 is set to “C” dBm.
The ratio between the initial setting period and the later setting period is 5:1, which is the same as the ratio of the number of subordinate QoS terminals.

“A” dBm used in the initial setting is the reception CCA threshold provisionally determined for the AP 1 by the method illustrated in FIG. 11. On the other hand, “D” dBm simultaneously used in the initial setting is the reception CCA threshold that can be used by the AP 2 without causing overlap with the detection area of the AP 1 in a case where the AP 1 uses “A” dBm. That is, the initial setting is a setting in which the optimum reception CCA threshold is given to the AP 1 and the transmission CCA threshold for avoiding interference with the AP 1 is given to the AP 2.

“C” dBm used in the later setting is the reception CCA threshold provisionally determined for the AP 2 by the method illustrated in FIG. 11. On the other hand, “B” dBm simultaneously used in the later setting is the reception CCA threshold that can be used by the AP 1 without causing overlap with the detection area of the AP 2 in a case where the AP 2 uses “C” dBm. That is, the later setting is a setting in which an optimal reception CCA threshold is given to the AP 2 and the transmission CCA threshold for avoiding interference with the AP 2 is given to the AP 1.

As illustrated with reference to FIG. 14, in the present embodiment, in a case where a plurality of the APs are disposed adjacent to each other, a setting for preferentially treating only a specific AP by using the provisionally determined reception CCA threshold is prepared by the number of APs. Then, the period of the preferential setting is allocated to each AP according to the ratio of the number of QoS terminals under the control of the AP. Therefore, in the CCA threshold determination system of the present embodiment, as in the first or second embodiment, it is possible to provide higher communication quality for the entire system while appropriately coordinating a plurality of the APs.

Note that, in the third embodiment described above, the number of QoSs under the control of the AP is used as the basis of the reception CCA threshold, but a value that can be obtained as the basis is not limited to “the number of subordinate QoSs”. For example, the number of STAS under the control of the AP, the frequency or air time of QoS frames generated under the control of the AP, or the like may be replaced with “the number of subordinate STAs” and used.

Furthermore, the switching between the initial setting and the later setting may be repeated at regular time intervals, but the CCA threshold may be separated according to the QoS frame generation cycle of the subordinate STA. That is, since the QoS frame count is performed by the AP controller 10, the generation cycle may be predicted on the basis of this information.

### Modification Examples of First to Third Embodiments

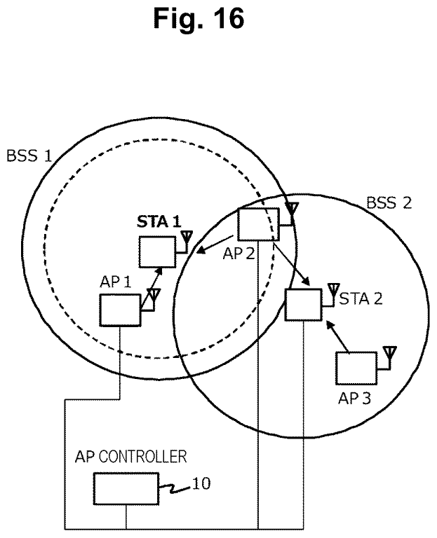

The operation described above may be performed by swapping the function of the AP and the function of the STA. As illustrated in FIG. 16, a reference power value when the STA 1 determines the reception CCA threshold may be determined by the methods of the first to third embodiments or the modification examples thereof on the basis of the reception power values from the AP 1 and AP 2 with which the STA 1 is associated, the reception power value from the unassociated AP 3, the QoS frame ratio in a frame transmitted by each of the APs 1 to 3, or the like. In this case, the STA may directly communicate with the AP controller 10 to exchange the information regarding the CCA threshold and the statistical information. Alternatively, the STA may exchange these pieces of information with the AP controller 10 via the AP.

Furthermore, in the first to third embodiments described above, the transmission CCA threshold is set in consideration of only the BSS color of the carrier sensing frame. However, the present disclosure is not limited thereto. For example, in a case where the QoS color is included in the carrier sensing frame, the transmission CCA threshold may be lowered in order to protect the QoS frame. Furthermore, in a case where the frame to be transmitted by the STA 1 is a QoS frame, the transmission CCA threshold may be changed to a large value in order to secure a transmission opportunity.

Furthermore, in the first to third embodiments described above, the transmission CCA threshold and the reception CCA threshold are individually set, but the present disclosure is not limited thereto. The reception CCA threshold may be determined and this may be applied to the transmission CCA threshold.

### Reference Signs List

AP1, AP2, AP12 Base Station
STA1, STA2, STA22, STA1a, STA1b, STA2a, STA2b Terminal
Tha Default value of CCA threshold
Thb Increase value of CCA threshold
BSS Basic Service Set

1. A CCA threshold determination system that determines a CCA threshold used in a wireless communication system including a plurality of wireless communicators configured by base stations or terminals,
at least two of the wireless communicators being configured to perform:
carrier sensing to determine presence or absence of a frame having a reception power value equal to or greater than a transmission CCA threshold when a transmission request occurs;
transmission of a frame in a case where the absence of the frame having the reception power value equal to or greater than the transmission CCA threshold is confirmed as a result of the carrier sensing; and
ignoring of a frame having a reception power value less than the reception CCA threshold and decoding the frame having a reception power value equal to or greater than the reception CCA threshold, and
the CCA threshold determination system comprising a controller that notifies the at least two of the wireless communicators of the reception CCA threshold,
wherein the controller is configured to perform:
receiving statistical information regarding an environment for receiving the frame from each of the at least two of the wireless communicators;
setting of the reception CCA threshold suitable for each of the at least two of the wireless communicators on a basis of the statistical information; and
notifying to the at least two of the wireless communicators of the reception CCA thresholds being set, and
the setting of the reception CCA threshold includes setting of a value at which each of the at least two of the wireless communicators easily decodes a frame addressed to its own BSS and easily ignores a frame addressed to another BSS, the value providing a desired balance to frame detection areas of the at least two of the wireless communicators.

2. The CCA threshold determination system according to claim 1,
wherein the setting of the reception CCA threshold includes:
provisionally determining a threshold for generating an optimum frame detection area for each of the at least two of the wireless communicators as the reception CCA threshold;
specifying one reference communicator among the at least two of the wireless communicators;
finalizing the provisionally determined threshold as the reception CCA threshold for the reference communicator; and
finalizing a threshold that achieves the desired balance in combination with the finalized reception CCA threshold of the reference communicator as the reception CCA threshold for a wireless communicator obtained by excluding the reference communicator from the at least two of the wireless communicators.

3. The CCA threshold determination system according to claim 2,
wherein the specifying one reference communicator includes:
counting the number of subordinate QoS communicators for each of the at least two of the wireless communicators on a basis of the statistical information, the QoS communicator being a wireless communicator that transmits a high-priority frame; and
setting, as the reference communicator, a wireless communicator that has the most QoS communicators as subordinate communicators.

4. The CCA threshold determination system according to claim 2,
wherein the setting of the reception CCA threshold further includes counting the number of subordinate wireless communicators for each of the at least two of the wireless communicators on a basis of the statistical information,
the specifying one reference communicator includes:
setting a priority time allocated by a ratio of the numbers of subordinate wireless communicators for each of the at least two of the wireless communicators; and
maintaining each of the at least two of the wireless communicators as the reference communicator only for the priority time and sequentially changing the reference communicator every time the priority time elapses.

5. The CCA threshold determination system according to claim 1,
wherein the setting of the reception CCA threshold includes:
counting the number of subordinate wireless communicators for each of the at least two of the wireless communicators on a basis of the statistical information; and
setting, for each of the at least two of the wireless communicators, the reception CCA threshold such that a ratio of radii of detection areas matches a ratio of the numbers of subordinate wireless communicators.

6. A CCA threshold determination device that determines a CCA threshold used by a wireless communicator in a wireless communication system including a plurality of the wireless communicators configured by base stations or terminals, the CCA threshold determination device being configured to perform:
receiving statistical information regarding an environment for receiving a frame from at least two of the wireless communicators;
setting of a reception CCA threshold suitable for each of the at least two of the wireless communicators on a basis of the statistical information; and
notifying to each of the at least two of the wireless communicators of the reception CCA threshold being set,
wherein the setting of the reception CCA threshold includes setting of a value at which each of the at least two of the wireless communicators easily decodes a frame addressed to its own BSS and easily ignores a frame addressed to another BSS, the value providing a desired balance to frame detection areas of the at least two of the wireless communicators.

7. A CCA threshold determination method for determining a CCA threshold used in a wireless communication system including a plurality of wireless communicators configured by base stations or terminals, the method including, causing at least two of the wireless communicators to perform:
carrier sensing to determine presence or absence of a frame having a reception power value equal to or greater than a transmission CCA threshold when a transmission request occurs;
transmission of a frame in a case where the absence of the frame having the reception power value equal to or greater than the transmission CCA threshold is confirmed as a result of the carrier sensing; and
ignoring of a frame having a reception power value less than the reception CCA threshold and decoding the frame having a reception power value equal to or greater than the reception CCA threshold, and
causing a controller that notifies the at least two of the wireless communicators of the reception CCA threshold to perform:
receiving statistical information regarding an environment for receiving the frame from the at least two of the wireless communicators;
setting of the reception CCA threshold suitable for each of the at least two of the wireless communicators on a basis of the statistical information; and
notifying to the at least two of the wireless communicators of the reception CCA thresholds being set,
wherein the reception CCA threshold is a value at which each of the at least two of the wireless communicators easily decodes a frame addressed to its own BSS and easily ignores a frame addressed to another BSS, the value providing a desired balance to frame detection areas of the at least two of the wireless communicators.

8. A computer readable storage medium storing a CCA threshold determination program for determining a CCA threshold used by a wireless communicator in a wireless communication system including a plurality of the wireless communicators configured by base stations or terminals, the CCA threshold determination program being computer-readable, and causing a controller having a function of exchanging information with at least two of the wireless communicators to execute the CCA threshold determination method according to claim 7.
